(19) United States
(12) Patent Application Publication
(10) Pub. No.: US 2014/0056457 A1
(43) Pub. Date: Feb. 27, 2014

(54) FIXER FOR LOUDSPEAKER AND ELECTRONIC DEVICE USING THE SAME

(71) Applicant: ASKEY COMPUTER CORP., New Taipei City (TW)

(72) Inventor: Chun-Hsiang HSU, New Taipei City (TW)

(73) Assignee: ASKEY COMPUTER CORP., New Taipei City (TW)

(21) Appl. No.: 13/686,589

(22) Filed: Nov. 27, 2012

(30) Foreign Application Priority Data
Aug. 27, 2012 (TW) 101130978

(51) Int. Cl. H04R 1/02

(52) U.S. Cl. CPC H04R 1/025
USPC 381/332

(57) ABSTRACT

A fixer for a loudspeaker includes a hollow frame, a pressing part, a positioning part and a fixing part. The hollow frame is disposed around a loudspeaker to limit the displacement of the loudspeaker. The pressing part is disposed on an inner surface of the hollow frame to press the loudspeaker. The positioning part is disposed on one side of the hollow frame, and the fixing part is disposed on another side of the hollow frame. An electronic device using the fixer for a loudspeaker is also disclosed.

### CROSS REFERENCE TO RELATED APPLICATIONS

This Non-provisional application claims priority under 35 U.S.C. §119(a) on Patent Application No(s). 101130978 filed in Taiwan, Republic of China on Aug. 27, 2012, the entire contents of which are hereby incorporated by reference.

### BACKGROUND OF THE INVENTION

1. Field of Invention

The invention relates to a fixer and, in particular, to a fixer for a loudspeaker and an electronic device using the fixer.

2. Related Art

The early electronic devices, such as cell phones and computers, need to be connected with an external loudspeaker to possess the loudspeaking function. However, with the improved technology, the loudspeaker has been installed in the various electronic devices, such as smart phones, non-smart phones, and tablet computers.

To install the loudspeaker in the electronic device, a fixing means is necessarily disposed for fixing the loudspeaker and the electronic device together firmly. As shown in FIG. 1, in the conventional art, a strip structure 11 and two screws 12 are commonly used to fix the loudspeaker 13 with the electronic device 14. In this method, the contact area of the strip structure 11 and the loudspeaker 13 is a strip-like area. However, when the electronic device undergoes a strict falling-down test, it will be easily damaged because the impact can not be dispersed rapidly due to the over concentrated contact area.

Therefore, it is an important subject to provide a fixer for a loudspeaker that is hard to get damaged when undergoing a strict falling-down test so as to improve the quality of the electronic device.

### SUMMARY OF THE INVENTION

In view of the foregoing subject, an objective of the invention is to provide a fixer for a loudspeaker and an electronic device having the fixer, in which the probability of the loudspeaker damaged by the impact is decreased a lot when undergoing a strict falling-down test because the impact can be dispersed widely. Thereby, the whole quality of the electronic device is enhanced.

To achieve the above objective, a fixer for a loudspeaker of the invention comprises a hollow frame, a pressing part, a positioning part and a fixing part. The hollow frame is disposed around a loudspeaker to limit the displacement of the loudspeaker. The pressing part is disposed on an inner surface of the hollow frame to press the loudspeaker. The positioning part is disposed on a side of the hollow frame. The fixing part is disposed on another side of the hollow frame.

In one embodiment, the hollow frame has at least one bent part.

In one embodiment, the positioning part is a C-shaped structure, a hole structure, or a pillar structure.

In one embodiment, the fixing part is a hole structure or a pillar structure.

In one embodiment, the hollow frame, the pressing part, the positioning part, and the fixing part are integrally formed as one piece.

To achieve the above objective, an electronic device having a fixer for a loudspeaker of the invention comprises a device body, a loudspeaker and a fixer. The device body has a containing space, a first connection part, and a second connection part. The loudspeaker is disposed at the containing space. The fixer includes a hollow frame, a pressing part, a positioning part, and a fixing part. The hollow frame is disposed around the loudspeaker. The pressing part is disposed on an inner surface of the hollow frame. The pressing part and a portion of the hollow frame contact a plurality of sides of a surface of the loudspeaker to press the loudspeaker. The positioning part is disposed on a side of the hollow frame and connected with the first connection part. The fixing part is disposed on another side of the hollow frame and connected with the second connection part.

In one embodiment, the hollow frame has at least one bent part.

In one embodiment, the positioning part is a C-shaped structure, a hole structure, or a pillar structure, and connected with the first connection part by locking or wedging.

In one embodiment, the fixing part is a hole structure or a pillar structure, and connected with the second connection part by locking or wedging.

In one embodiment, the electronic device further comprises a frame having a third connection part that is connected with the first connection part or the positioning part.

In one embodiment, the hollow frame, the pressing part, the positioning part, and the fixing part are integrally formed as one piece.

As mentioned above, the fixer for a loudspeaker includes a pressing part, a positioning part and a fixing part, so that it can provide multiple contacts and thus disperse the impact during a strict falling-down test. Accordingly, the probability of the loudspeaker damaged by the impact is decreased and the whole quality of the electronic device is enhanced.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram of the conventional art;

FIG. 2 is a schematic diagram of a fixer for a loudspeaker of a preferred embodiment of the invention;

FIG. 3A is a schematic diagram of another fixer for a loudspeaker of the preferred embodiment of the invention;

FIG. 3B is a schematic diagram of another fixer for a loudspeaker of the preferred embodiment of the invention;

FIG. 4 is a schematic diagram of an electronic device with a fixer and a loudspeaker of a preferred embodiment of the invention; and

FIG. 5 is a schematic diagram of an electronic device with a fixer and a loudspeaker of another preferred embodiment of the invention.

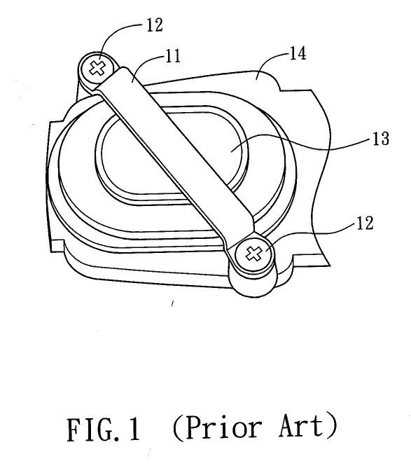

### DETAILED DESCRIPTION OF THE INVENTION

The present invention will be apparent from the following detailed description, which proceeds with reference to the accompanying drawings, wherein the same references relate to the same elements.

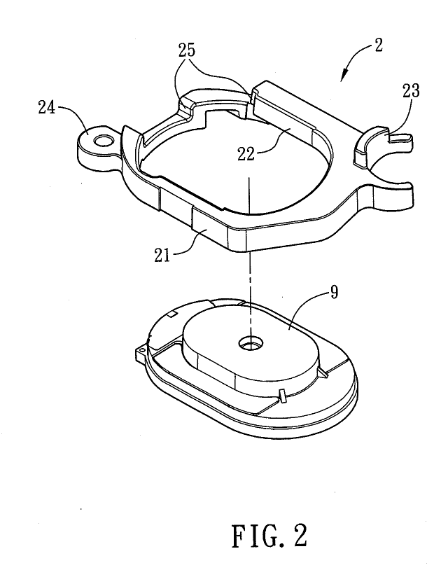

FIG. 2 is a schematic diagram of a fixer for a loudspeaker of a preferred embodiment of the invention. The fixer 2 includes a hollow frame 21, a pressing part 22, a positioning part 23 and a fixing part 24.

The hollow frame 21 is disposed around a loudspeaker 9 to limit the displacement of the loudspeaker 9. The material of the hollow frame 21 is, for example, plastic, metal, or alloy. A portion of the hollow frame 21 contacts a plurality of sides of a surface of the loudspeaker 9 to limit the displacement of the loudspeaker 9. To be noted, the shape of the hollow frame 21 as shown in FIG. 2 is just for example, and in other embodiments, it can have various shapes corresponding to the various loudspeaker 9.

The pressing part 22 is disposed on an inner surface of the hollow frame 21. The pressing part 22 can be an extension of the inner surface of the hollow frame 21, or an individual thing attached to the inner surface of the hollow frame 21 after being made beforehand. Therefore, the pressing part 22 and the hollow frame 21 can have the same material or different material. In the embodiment, the pressing part 22 is an extension of the inner surface of the hollow frame 21, and has the same material as the hollow frame 21. The pressing part 22 contacts a plurality of sides of a surface of the loudspeaker 9 to press the loudspeaker 9 for limiting its displacement.

The positioning part 23 is disposed on a side of the hollow frame 21. The positioning part 23 can be an extension of the hollow frame 21, or a thing attached to the hollow frame 21 after being made beforehand. Therefore, the material of the positioning part 23 can be the same as or different from the hollow frame 21. In the embodiment, the positioning part 23 is a C-shaped structure, an extension of the hollow frame 21 with the same material as the hollow frame 21. The positioning part 23 is for positioning the fixer 2 to prevent the fixer 2 from deviating from a predetermined position.

The fixing part 24 is disposed on another side of the hollow frame 21, for example, the side opposite to the positioning part 23. The fixer 24 can be an extension of the hollow frame 21, or a thing attached to the hollow frame 21 after being made beforehand. Therefore, the material of the fixer 24 can be the same as or different from the hollow frame 21. In the embodiment, the fixing part 24 is a hole structure, an extension of the hollow frame 21 with the same material as the hollow frame 21. The fixing part 24 is for fixing the fixer 2 to a predetermined location.

Preferably, the hollow frame 21, the pressing part 22, the positioning part 23 and the fixing part 24 are integrally formed as one piece. For example, they can be formed in a mold by injection molding so as to decrease the cost. Otherwise, according to the practical application, they can be separately made and then assembled together.

Additionally, the hollow frame 21 can further include at least one bent part. In the embodiment, the hollow frame 21 has two bent parts 25. Regarding the two bent parts as the datum, the hollow frame 21 is divided into two portions located at different levels. One of the portions is connected with the pressing part 22 to press three sides of a surface of the loudspeaker 9 for limiting its displacement. The other portion can be passed through by a circuit of the loudspeaker 9. To be noted, in the different embodiments, the hollow frame 21 can be designed differently corresponding to different loudspeakers. For example, the hollow frame is configured without the bent part, or just has a single bent part, or has three or more bent parts. The number and conformation of the bent part of the hollow frame are not limited in the invention.

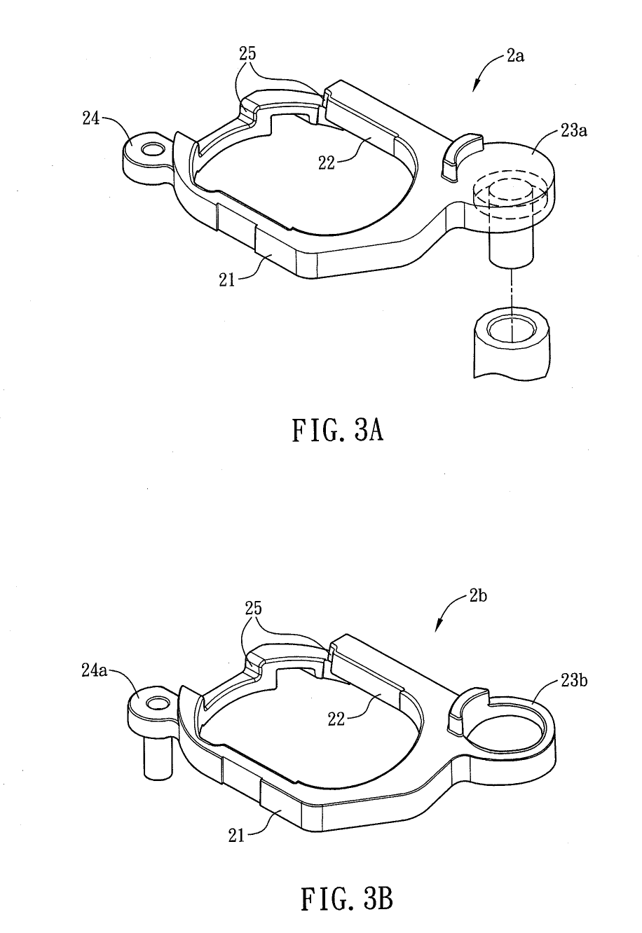

FIGS. 3A and 3B are schematic diagrams of other kinds of fixers for a loudspeaker of the preferred embodiment of the invention. As shown in FIG. 3A, the fixer 2a is almost the same as the fixer 2, and the main difference therebetween is that the positioning part 23a of the fixer 2a is a pillar structure. As shown in FIG. 3B, the fixer 2b is almost the same as the fixer 2, and the main difference therebetween is that the positioning part 23b of the fixer 2b is a hole structure while the fixing part 24a is a pillar structure. The structures as shown in FIGS. 3A and 3B are just for example, and can be designed differently according to the practical requirements for achieving the functions of positioning and fixing.

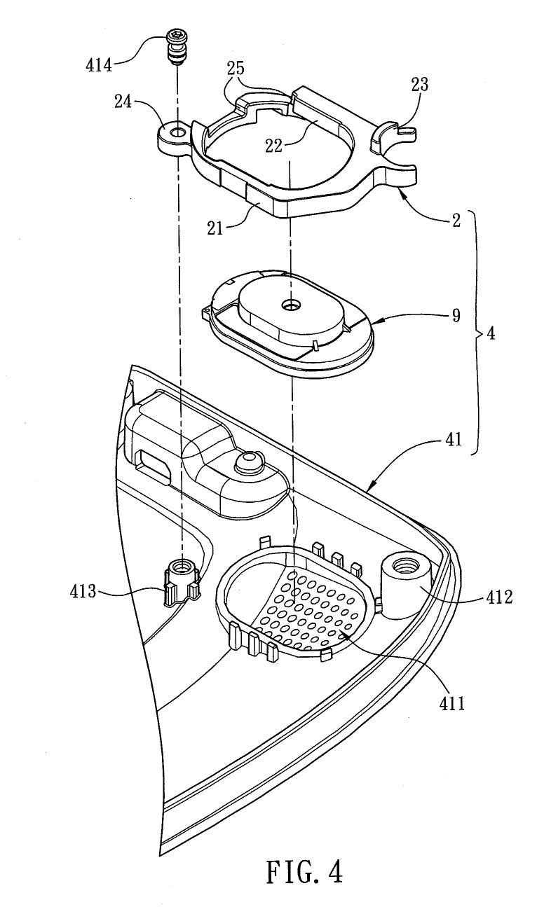

FIG. 4 is a schematic diagram of an electronic device with a fixer and a loudspeaker of a preferred embodiment of the invention. Referring to FIG. 4, the electronic device 4 includes a device body 41, a loudspeaker 9, and a fixer 2.

The device body 41 has a containing space 411, a first connection part 412, and a second connection part 413. In the embodiment, each of the first and second connection parts 412 and 413 is a hollow-pillar structure having threads at the inner side thereof. In other embodiments, the first and second connection parts can be designed differently, and for example, they can be hollow-pillar or taper structures without the threads.

The loudspeaker 9 is disposed in the containing space 411. The loudspeaker 9 can be attached to the device body 41 by an adhesive for the initial fixing.

The fixer 2 includes a hollow frame 21, a pressing part 22, a positioning part 23, and a fixing part 24. The fixer 2 can be understood by referring to FIG. 2 with the following illustration.

The hollow frame 21 is disposed around the loudspeaker 9. The material of the hollow frame 21 is, for example, plastic, metal, or alloy. A portion of the hollow frame 21 contacts a plurality of sides of a surface of the loudspeaker 9 to limit the displacement of the loudspeaker 9.

The pressing part 22 is disposed on an inner surface of the hollow frame 21. The pressing part 22 can be an extension of the inner surface of the hollow frame 21, or an individual thing attached to the inner surface of the hollow frame 21 after being made beforehand. Therefore, the pressing part 22 and the hollow frame 21 can have the same material or different material. In the embodiment, the pressing part 22 is an extension of the inner surface of the hollow frame 21, and has the same material as the hollow frame 21. The pressing part 22 contacts a plurality of sides of a surface of the loudspeaker 9 to press the loudspeaker 9 for limiting its displacement.

The positioning part 23 is disposed on a side of the hollow frame 21. The positioning part 23 can be an extension of the hollow frame 21, or a thing attached to the hollow frame 21 after being made beforehand. Therefore, the material of the positioning part 23 can be the same as or different from the hollow frame 21. In the embodiment, the positioning part 23 is a C-shaped structure, an extension of the hollow frame 21 with the same material as the hollow frame 21.

The positioning part 23 is connected with the first connection part 412. In the embodiment, the positioning part 23 as a C-shaped structure clips the first connection part 412 as a hollow-pillar structure so that the fixer 2 is fixed to a predetermined position.

The fixing part 24 is disposed on another side of the hollow frame 21, for example, the side opposite to the positioning part 23. The fixer 24 can be an extension of the hollow frame 21, or a thing attached to the hollow frame 21 after being made beforehand. Therefore, the material of the fixer 24 can be the same as or different from the hollow frame 21. In the embodiment, the fixing part 24 is a hole structure, an extension of the hollow frame 21 with the same material as the hollow frame 21.

The fixing part 24 is connected with the second connection part 413. In the embodiment, the second connection part 413 is sleeved with the fixing part 24, and then a first fixing element 414, such as a screw, is used to screw the fixer 2 to the second connection part 413. To be noted, the first fixing element 414 is not needed necessarily. In other embodiments, the fixing part can be capable of a fixing function on its own so that the mutual fixing can be achieved without the first fixing element.

Preferably, the hollow frame 21, the pressing part 22, the positioning part 23 and the fixing part 24 are integrally formed as one piece. For example, they can be formed in a mold by injection molding, which can reduce the cost. Otherwise, according to the practical application, they can be separately made and then assembled together.

Additionally, the hollow frame 21 can further include at least one bent part. In the embodiment, the hollow frame 21 has two bent parts 25. Regarding the two bent parts as the datum, the hollow frame 21 is divided into two portions located at different levels. One of the portions is connected with the pressing part 22 to press three sides of a surface of the loudspeaker 9 for limiting its displacement. The other portion can be passed through by a circuit (not shown) of the loudspeaker 9 so that the loudspeaker 9 can be electrically connected with a circuit of the device body 41. To be noted, in the different embodiments, the hollow frame 21 can be designed differently corresponding to the different loudspeakers or device bodies. For example, the hollow frame can be configured without the bent part, or just have a single bent part, or have three or more bent parts. The number and conformation of the bent part of the hollow frame are not limited in the invention.

To deserve to be mentioned, because the contact between the partial hollow frame 21 with the pressing part 22, and the loudspeaker 9 is achieved by a plurality of sides of the surfaces thereof, the impact can be dispersed to the sides instead of being concentrated to the center or one point of the loudspeaker 9. Therefore, the probability of the loudspeaker 9 damaged by the impact can be decreased a lot.

FIGS. 3A and 3B are schematic diagrams of other kinds of fixers for a loudspeaker of the preferred embodiment of the invention.

As shown in FIG. 3A, the fixer 2a is almost the same as the fixer 2, and the main difference therebetween is that the positioning part 23a of the fixer 2a is a pillar structure. In the embodiment, the positioning part 23a and the first connection part 412 are connected by wedging so that the fixer 2a is fixed to a predetermined position. As shown in FIG. 3B, the fixer 2b is almost the same as the fixer 2, and the main difference therebetween is that the positioning part 23b of the fixer 2b is a hole structure while the fixing part 24a is a pillar structure. In the embodiment, the first connection part 412 can be sleeved with the positioning part 23b, and then they can be fixed together by a screw so as to position the fixer 2b. The fixing part 24a can be connected with the second connection part 413 by wedging so as to fix the fixer 2b. The structures as shown in FIGS. 3A and 3B are just for example, and can be designed differently according to the practical requirements for achieving the functions of the positioning and fixing.

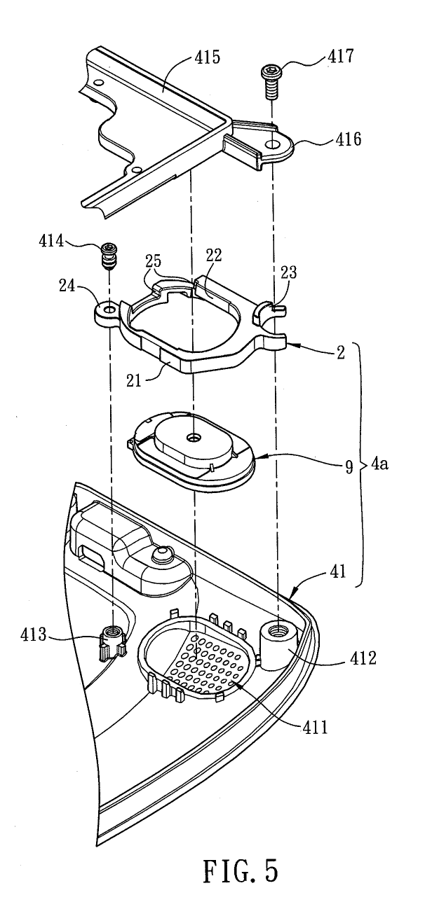

FIG. 5 is a schematic diagram of an electronic device with a fixer and a loudspeaker of another preferred embodiment. Referring to FIG. 5, the electronic device 4a is almost the same as the electronic device 4, and the main difference therebetween is that the electronic device 4a further includes a frame 415, which has a third connection part 416. The third connection part 416 is connected with the first connection part 412 or the positioning part 23. When they are connected together, a second fixing element 417, such as a screw, can be used to fix the frame 415 and the device body 41 together firmly. In this case, the fixer 2 is fixed between the frame 415 and the device body 41 so that the loudspeaker 9 is directly pressed by the connection of the frame 415 and the device body 41. Therefore, the displacement of the loudspeaker 9 is further limited.

To be noted, the frame 415 can be disposed to a housing (not shown), such as a back cover, or disposed independently. In other embodiments, the third connection part can be a tenon structure to connect the first connection part or the positioning part by wedging so that the second fixing element is not needed.

In summary, the fixer for a loudspeaker includes a pressing part, a positioning part and a fixing part, so that it can provide multiple contacts and thus disperse the impact during a strict falling-down test. Accordingly, the probability of the loudspeaker damaged by the impact is decreased and the whole quality of the electronic device is enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A fixer for a loudspeaker, comprising:
a hollow frame disposed around a loudspeaker to limit the displacement of the loudspeaker;
a pressing part disposed on an inner surface of the hollow frame to press the loudspeaker;
a positioning part disposed on a side of the hollow frame; and
a fixing part disposed on another side of the hollow frame.

2. The fixer as recited in claim 1, wherein the hollow frame has at least one bent part.

3. The fixer as recited in claim 1, wherein the positioning part is a C-shaped structure, a hole structure, or a pillar structure.

4. The fixer as recited in claim 1, wherein the fixing part is a hole structure or a pillar structure.

5. The fixer as recited in claim 1, wherein the hollow frame, the pressing part, the positioning part, and the fixing part are integrally formed as one piece.

6. An electronic device having a fixer for a loudspeaker, comprising:
a device body comprising a containing space, a first connection part, and a second connection part;
a loudspeaker disposed at the containing space; and
a fixer comprising a hollow frame, a pressing part, a positioning part, and a fixing part, wherein the hollow frame is disposed around the loudspeaker, the pressing part is disposed on an inner surface of the hollow frame, the pressing part and a portion of the hollow frame contact a plurality of sides of a surface of the loudspeaker to press the loudspeaker, the positioning part is disposed on a side of the hollow frame and connected with the first connection part, and the fixing part is disposed on another side of the hollow frame and connected with the second connection part.

7. The electronic device as recited in claim 6, wherein the hollow frame has at least one bent part.

8. The electronic device as recited in claim 6, wherein the positioning part is a C-shaped structure, a hole structure, or a pillar structure, and connected with the first connection part by locking or wedging.

9. The electronic device as recited in claim 6, wherein the fixing part is a hole structure or a pillar structure, and connected with the second connection part by locking or wedging.

10. The electronic device as recited in claim 6, further comprising:
a frame having a third connection part that is connected with the first connection part or the positioning part.

11. The electronic device as recited in claim 6, wherein the hollow frame, the pressing part, the positioning part, and the fixing part are integrally formed as one piece.
